(19) United States
(12) Patent Application Publication
(10) Pub. No.: US 2026/0154506 A1
(43) Pub. Date: Jun. 4, 2026

(54) Machine Learning Aspect Based Sentiment Analysis

(71) Applicant: Oracle International Corporation, Redwood Shores, CA (US)

(72) Inventors: Didugu PHANI SAI GANESH, Telangana (IN); Akash BAVISKAR, Dist Jalgaon (IN); Krishnan RAMANATHAN, Kadubeesanahalli (IN); Vikas AGRAWAL, Hyderabad (IN)

(21) Appl. No.: 18/964,785

(22) Filed: Dec. 2, 2024

(51) Int. Cl. G06F 40/30; G06N 20/00

(52) U.S. Cl. CPC G06F 40/30; G06N 20/00

(57) ABSTRACT

Embodiments evaluate performance by receiving a plurality of training performance reviews. Embodiments extract from the training performance reviews, using a first machine learning model, a plurality of features comprising a training aspect, a training sentiment, and a corresponding training evidence. Embodiments use the extracted plurality of features to train a second machine learning model. Embodiments receive a first performance review and extract from the first performance review one or more first aspects, one or more corresponding first evidences, and one or more corresponding first sentiments. Embodiments, using the trained second machine learning model, predict first sentiment scores for each of the first aspects.

### FIELD

One embodiment is directed generally to a computer system, and in particular to aspect based sentiment analysis by the computer system using machine learning.

### BACKGROUND INFORMATION

A performance review, also referred to as a performance appraisal, performance evaluation, or employee appraisal, is a method by which the job performance of an employee is documented and evaluated. Performance appraisals are a part of career development and consist of regular reviews of employee performance within organizations. Performance reviews are used to evaluate employees' contributions and determine outcomes such as salary increments and promotions.

Performance reviews are most often conducted by an immediate manager/supervisor, such as line managers or front-line managers. While assessment can be performed along reporting relationships (usually top-down), net assessment can include peer and self-assessment. Peer assessment is when assessment is performed by colleagues along both horizontal (similar function) and vertical (different function) relationships. Self-assessments are when individuals evaluate themselves.

Peer assessments and self-assessments are increasingly popular and are typically combined as a “360-degree feedback” (also known as multi-rater feedback, multi source feedback, or multi source assessment). 360-degree feedback is a process through which feedback from an employee's subordinates, colleagues, and supervisor(s), as well as a self-evaluation by the employee themselves is gathered. Such feedback can also include, when relevant, feedback from external sources who interact with the employee, such as customers and suppliers or other interested stakeholders. 360-degree feedback is so named because it solicits feedback regarding an employee's behavior from a variety of points of view (subordinate, lateral, and supervisory). It therefore may be contrasted with “downward feedback” (traditional feedback on work behavior and performance delivered to subordinates by supervisory or management employees only), or “upward feedback” delivered to supervisory or management employees by subordinates only.

However, performance reviews generally involve assessing various performance aspects and providing a judgment that is often reduced to a numerical rating on a scale of 1 to 5 or some other numerical scale. This reduction leads to a loss of nuanced information and fails to capture the comprehensive insights gained from detailed evaluations. Further, the year-over-year trend of performance ratings generally do not provide any valuable information, missing out on providing valuable insights into specific performance aspects where employees improved or declined.

### SUMMARY

Embodiments evaluate performance by receiving a plurality of training performance reviews. Embodiments extract from the training performance reviews, using a first machine learning model, a plurality of features comprising a training aspect, a training sentiment, and a corresponding training evidence. Embodiments use the extracted plurality of features to train a second machine learning model. Embodiments receive a first performance review and extract from the first performance review one or more first aspects, one or more corresponding first evidences, and one or more corresponding first sentiments. Embodiments, using the trained second machine learning model, predict first sentiment scores for each of the first aspects.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments one element may be designed as multiple elements or that multiple elements may be designed as one element. In some embodiments, an element shown as an internal component of another element may be implemented as an external component and vice versa. Furthermore, elements may not be drawn to scale.

FIG. 1 illustrates an example of a system that includes an aspect based sentiment analysis system in accordance to embodiments.

FIG. 2 is a block diagram of the aspect based sentiment analysis system of FIG. 1 in the form of a computer server/system in accordance to an embodiment of the present invention.

FIG. 3 is a flow/block diagram of the functionality of the aspect based sentiment analysis system of FIG. 1 and associated elements when providing aspect based sentiment analysis for performance reviews and other uses in accordance with one embodiment.

FIGS. 4-8 illustrate an example data analytics environment in accordance with an embodiment.

### DETAILED DESCRIPTION

Embodiments implement a first machine learning (“ML”) model to process and understand textual data from a performance review, enabling a more comprehensive and nuanced analysis than traditional methods, to extract aspects and, evidence out of the review, along with sentiments and aspect weights. Embodiments implement a second ML model that assigns the sentiment and a sentiment score to the given review, aspect and evidence triplet. The sentiments extracted by the first ML model as features, are utilized as target labels to train the second ML model. The second ML model produces sentiment scores as an intermediate output during the prediction of sentiments. Embodiments use these sentiment scores, to extract sentiment mismatch score. Embodiments further provide actionable insights and targeted recommendations, helping organizations make informed decisions.

In general, in response to receiving (Manager Review, Employee Review) from the performance review process, there is a need to generate (Manager Review, Employee Review, Aspect, Manager Sentiment, Employee Sentiment, Alignment). Therefore, embodiments need to perform: (1) Aspect Term Extraction (“ATE”): Given a sentence, extract the aspects from it; and (2) Aspect Based Sentiment Analysis (“ABSA”): Given a sentence+aspect, identify the sentiment of the aspect in the sentence. However, known deep learning models generally require custom data sets for both ATE and ABSA tasks.

In contrast, embodiments utilize large language models (“LLMs”) to extract the (aspects, evidence, sentiment, aspect weight) quadruples from the performance reviews. In response to prompting, embodiments enable LLMs to identify and categorize performance aspects such as teamwork, problem-solving, communication skills, etc. For example, when a review states “excellent problem-solving skills,” LLMs categorize it under “Problem-Solving” aspect with a POSITIVE sentiment. Aspect weighting ensures that critical performance areas receive appropriate emphasis, reflecting their significance in overall evaluations.

Embodiments enhance the LLM accuracy by incorporating job-specific context (e.g., industry, role, location). For example: (1) “Two accidents under his supervision last year” can be interpreted differently based on context—neutral for a foundry worker but negative for a truck driver; or (2) For a truck driver, punctuality might have high aspect weight whereas for a scientist, innovation is given high aspect weight.

Reference will now be made in detail to the embodiments of the present disclosure, examples of which are illustrated in the accompanying drawings. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, components, and circuits have not been described in detail so as not to unnecessarily obscure aspects of the embodiments. Wherever possible, like reference numbers will be used for like elements.

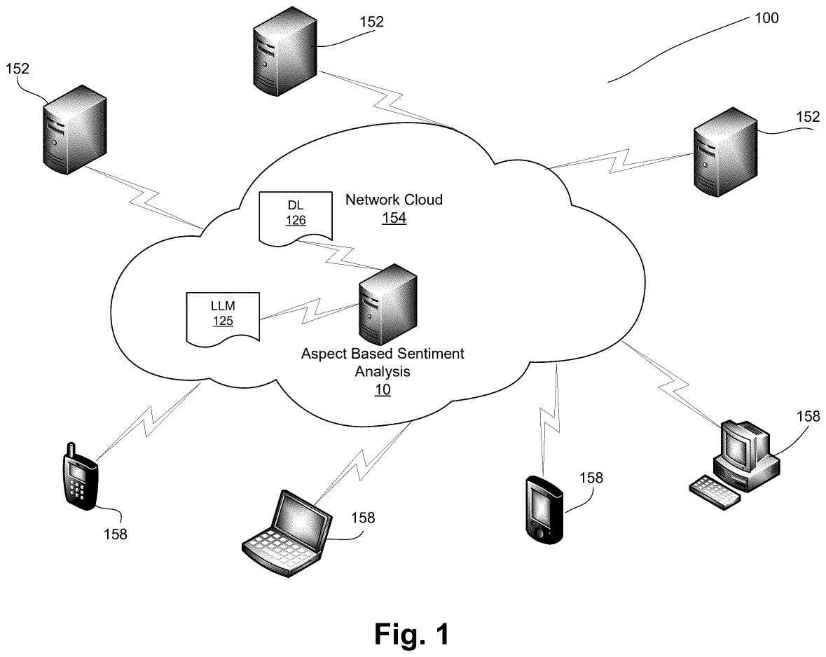

FIG. 1 illustrates an example of a system 100 that includes an aspect based sentiment analysis system 10 in accordance to embodiments. Aspect based sentiment analysis system 10 may be implemented within a computing environment that includes a communication network/cloud 154. Network 154 may be a private network that can communicate with a public network (e.g., the Internet) to access additional services 152 provided by a cloud services provider. Examples of communication networks include a mobile network, a wireless network, a cellular network, a local area network (“LAN”), a wide area network (“WAN”), other wireless communication networks, or combinations of these and other networks. Aspect based sentiment analysis system 10 may be administered by a service provider, such as via the Oracle Cloud Infrastructure (“OCI”) from Oracle Corp.

Tenants of the cloud services provider can be companies or any type of organization or groups whose members include users of services offered by the service provider. Services may include or be provided as access to, without limitation, an application, a resource, a file, a document, data, media, or combinations thereof. Users may have individual accounts with the service provider and organizations may have enterprise accounts with the service provider, where an enterprise account encompasses or aggregates a number of individual user accounts.

System 100 further includes client devices 158, which can be any type of device that can access network 154 and can obtain the benefits of the functionality of aspect based sentiment analysis system 10 for analyzing performance reviews. As disclosed herein, a “client” (also disclosed as a “client system” or a “client device”) may be a device or an application executing on a device. System 100 includes a number of different types of client devices 158 that each is able to communicate with network 154.

Executing on cloud 154 (or otherwise in communication with aspect based sentiment analysis system 10) is at least one large language model (“LLM”) 125. An LLM is a type of artificial intelligence (“AI”) model that is trained on a large amount of text data. An LLM can generate text, translate text from one language to another, write different kinds of creative content, and answer questions in an informative way. In general, an LLM is a machine that has been taught to understand and use language the way that humans do. An LLM can read and write, and can understand and respond to complex questions. Examples of LLMs that can be used in embodiments include “ChatGPT”, “Bard AI”, and various opens source LLMs. Embodiments can be implemented with any sufficiently large LLM. However, LLMs trained with domain specific data can provide more accurate results.

Also executing on cloud 154 (or otherwise in communication with aspect based sentiment analysis system 10) is at least one deep learning model 126. Deep learning is a subset of machine learning that focuses on utilizing neural networks to perform tasks such as classification, regression, and representation learning. Deep learning refers to a class of machine learning algorithms in which a hierarchy of layers is used to transform input data into a slightly more abstract and composite representation. Deep learning network architectures/models, such as deep learning model 126, may include fully connected networks, deep belief networks, recurrent neural networks, convolutional neural networks, generative adversarial networks, transformers, neural radiance fields, etc.

LLMs are a specialized type of deep learning model designed for natural language processing (“NLP”) tasks, such as text generation, summarization, and translation. While general deep learning models include several architectures such as CNNs (images) or RNNs (time series), LLMs are mainly transformer-based and trained on very large text datasets. LLMs are characterized by their scale, with state of the art models hitting 100 billions parameters, and require significant computational resources.

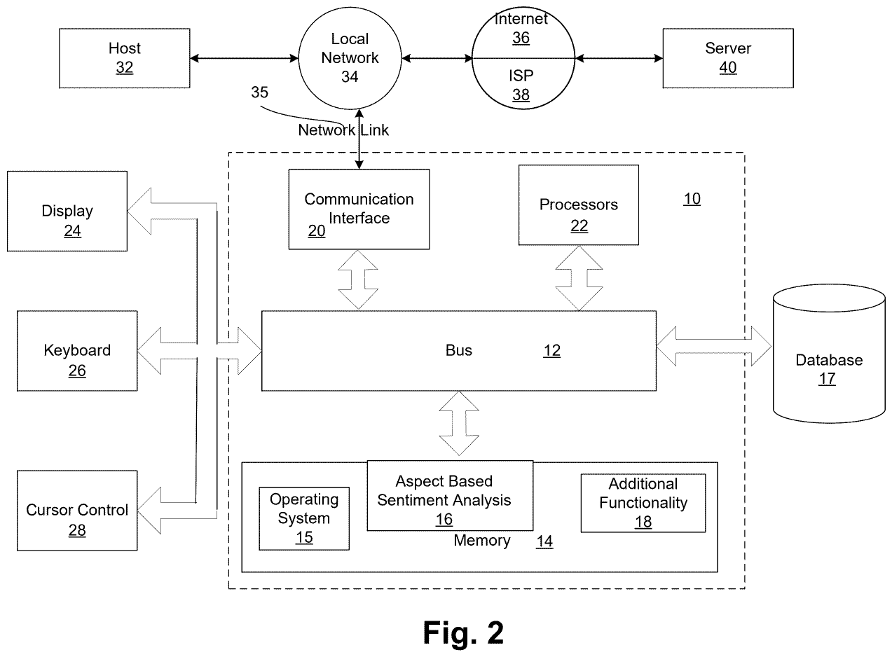

FIG. 2 is a block diagram of aspect based sentiment analysis system 10 of FIG. 1 in the form of a computer server/system 10 in accordance to an embodiment of the present invention. Although shown as a single system, the functionality of system 10 can be implemented as a distributed system. Further, the functionality disclosed herein can be implemented on separate servers or devices that may be coupled together over a network. Further, one or more components of system 10 may not be included. One or more components of FIG. 2 can also be used to implement any of the elements of FIG. 1.

System 10 includes a bus 12 or other communication mechanism for communicating information, and a processor 22 coupled to bus 12 for processing information. Processor 22 may be any type of general or specific purpose processor. System 10 further includes a memory 14 for storing information and instructions to be executed by processor 22. Memory 14 can be comprised of any combination of random access memory (“RAM”), read only memory (“ROM”), static storage such as a magnetic or optical disk, or any other type of computer readable media. System 10 further includes a communication interface 20, such as a network interface card, to provide access to a network. Therefore, a user may interface with system 10 directly, or remotely through a network, or any other method.

Computer readable media may be any available media that can be accessed by processor 22 and includes both volatile and nonvolatile media, removable and non-removable media, and communication media. Communication media may include computer readable instructions, data structures, program modules, or other data in a modulated data signal such as a carrier wave or other transport mechanism, and includes any information delivery media.

Processor 22 is further coupled via bus 12 to a display 24, such as a Liquid Crystal Display (“LCD”). A keyboard 26 and a cursor control device 28, such as a computer mouse, are further coupled to bus 12 to enable a user to interface with system 10.

In one embodiment, memory 14 stores software modules that provide functionality when executed by processor 22. The modules include an operating system 15 that provides operating system functionality for system 10. The modules further include an aspect based sentiment analysis module 16 that provides aspect based sentiment analysis for performance reviews and other uses, and all other functionality disclosed herein. System 10 can be part of a larger system. Therefore, system 10 can include one or more additional functional modules 18, such as a business intelligence or data warehouse application (e.g., “Human Capital Management” (“HCM”) from Oracle Corp.) that utilizes the aspect based sentiment analysis functionality. A file storage device or database 17 is coupled to bus 12 to provide centralized storage for modules 16 and 18, including training data used to generate the ML models. In one embodiment, database 17 is a relational database management system (“RDBMS”) that can use Structured Query Language (“SQL”) to manage the stored data.

In embodiments, communication interface 20 provides a two-way data communication coupling to a network link 35 that is connected to a local network 34. For example, communication interface 20 may be an integrated services digital network (“ISDN”) card, cable modem, satellite modem, or a modem to provide a data communication connection to a corresponding type of telephone line or Ethernet. As another example, communication interface 20 may be a local area network (“LAN”) card to provide a data communication connection to a compatible LAN. Wireless links may also be implemented. In any such implementation, communication interface 20 sends and receives electrical, electromagnetic or optical signals that carry digital data streams representing various types of information.

Network link 35 typically provides data communication through one or more networks to other data devices. For example, network link 35 may provide a connection through local network 34 to a host computer 32 or to data equipment operated by an Internet Service Provider (“ISP”) 38. ISP 38 in turn provides data communication services through the Internet 36. Local network 34 and Internet 36 both use electrical, electromagnetic or optical signals that carry digital data streams. The signals through the various networks and the signals on network link 35 and through communication interface 20, which carry the digital data to and from computer system 10, are example forms of transmission media.

System 10 can send messages and receive data, including program code, through the network(s), network link 35 and communication interface 20. In the Internet example, a server 40 might transmit a requested code for an application program through Internet 36, ISP 38, local network 34 and communication interface 20. The received code may be executed by processor 22 as it is received, and/or stored in database 17, or other non-volatile storage for later execution.

In one embodiment, system 10 is a computing/data processing system including an application or collection of distributed applications for enterprise organizations, and may also implement logistics, manufacturing, and inventory management functionality. The applications and computing system 10 may be configured to operate locally or be implemented as a cloud-based networking system, for example in an infrastructure-as-a-service (“IAAS”), platform-as-a-service (“PAAS”), software-as-a-service (“SAAS”) architecture, or other type of computing solution.

As disclosed, performance reviews are typically reduced to numerical ratings. Even when textual comments accompany the ratings, they are often stored as unstructured data, making it challenging to analyze and derive meaningful insights. Traditional Natural Language Processing (“NLP”) techniques used for feature extraction from textual data have inherent limitations, such as handling subjectivity and context sensitivity. While ML, including deep learning (“DL”) models, offer advanced capabilities, they generally require specialized datasets to perform effectively. Models trained on standard benchmark datasets, such as “IMDb” movie reviews or restaurant reviews, often fail to capture the nuances of performance review text accurately. As a result, organizations face the challenge of creating and labelling performance evaluation review data, which is both costly and resource-intensive. Therefore, organizations generally struggle to answer critical business questions such as identifying the strengths and weaknesses of a team, understanding managerial expectations and detecting potential communication gaps.

The inadequacy of numerical ratings in capturing the full scope of employee performance leads to a need for a more granular and detailed analysis. Embodiments solve this need by implementing a comprehensive review system that provides one or more of: (1) Granular sentiment analysis for understanding specific aspects of performance rather than relying solely on overall ratings; (2) Context-aware feature extraction for considering industry, job role, and other relevant factors to accurately interpret performance review text data; (3) Sentiment alignment for comparing and contrasting the sentiments expressed in manager and employee performance evaluation comments to identify alignment or discrepancies; and (4) Actionable insights for providing clear, actionable recommendations to employees based on performance reviews, helping them improve.

Embodiments implement an end-to-end framework for analyzing employee performance reviews using transformer based deep learning models and statistical techniques. Embodiments use LLMs to process and understand textual data, enabling a more comprehensive and nuanced analysis than traditional methods, to extract aspects and evidence out of the review. Embodiments implement a transformer based deep learning model that assigns the sentiment and sentiment score to the given review, aspect, evidence triplet. Embodiments further generate actionable insights and targeted recommendations, helping organizations make informed decisions.

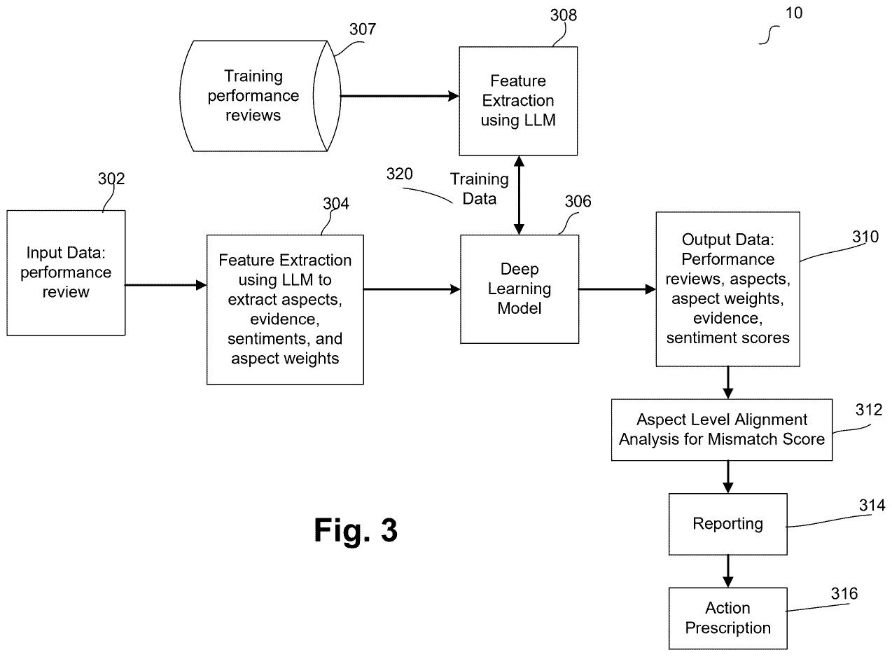

FIG. 3 is a flow/block diagram of the functionality of aspect based sentiment analysis system 10 of FIG. 1 and associated elements when providing aspect based sentiment analysis for performance reviews and other uses in accordance with one embodiment. In one embodiment, the functionality of the flow diagram of FIG. 3 is implemented by software stored in memory or other computer readable or tangible medium, and executed by a processor. In other embodiments, the functionality may be performed by hardware (e.g., through the use of an application specific integrated circuit (“ASIC”), a programmable gate array (“PGA”), a field programmable gate array (“FPGA”), etc.), or any combination of hardware and software.

At 307, embodiments fetch/retrieve input training performance review data. In embodiments, this data is retrieved from an HCM database as historical/past performance reviews. For each employee, embodiments gather two sets of comments: one from the employee's self-evaluation and the other from the manager's assessment. This dual perspective allows for a comprehensive understanding of the employee's performance and helps in identifying any discrepancies in perceptions. Self-evaluations provide insights into the employee's perspective, highlighting personal achievements and self-assessed strengths. Manager reviews offer an external, objective view, focusing on performance metrics and alignment with organizational goals. Analyzing both reviews captures the alignment or misalignment between employee and manager perspectives, enhancing feedback quality, fostering transparency, and building trust by considering multiple viewpoints. In embodiments, the training performance reviews at 307, and the “live” performance review at 302, consists solely of textual data from the supervisor and the employee.

In embodiments, for the purpose of extracting the (aspect, evidence, sentiment, aspect weight) quadruple, a sample set of 10 to 15 training performance reviews at 307 may be sufficient for using few-shot prompting technique. The more diverse this set is, the better the LLM can understand the objective and will be more accurate in the results. “Few-shot prompting” is a technique used in prompt engineering, particularly in natural language processing (“NLP”) tasks involving large language models such as ChatGPT. The term “few-shot” refers to the number of examples provided within the prompt to guide the model's output. The 10-15 reviews can be retrieved from an internal dataset or created manually, and do not have to be tuned particular to an organization. In other embodiments, for shot prompting techniques, information related to the organization is included (the industry of the organization, etc.) so that the LLM will have better context when it is extracting the aspect quadruples. LLMs 125 can be implemented by generally available LLMs such as “ChatGPT”, “Meta”, “Gemini”, etc. The few shot prompting techniques (e.g., using 10-15 samples) automatically tunes this LLM to do the task of aspect quadruple extraction. In other embodiments, a specialized LLM can be used that is fine tuned for the specific aspect quadruple extraction task at hand.

At 308, one or more LLMs 125 extract features from the historical performance reviews. In embodiments, the feature extraction functionality at 308 includes aspect and evidence identification, contextual understanding, and aspect weights. For feature extraction phase, embodiments utilize LLMs to identify and extract critical features from performance review comments. This process involves the following elements:

Aspect and Evidence Identification: Embodiments employ LLMs 125 to identify and categorize various aspects of performance mentioned in the reviews. These aspects include attributes such as teamwork, problem-solving, communication skills, and project management. For example, if a review mentions “excellent problem-solving skills” and “proactive communication,” embodiments train the LLM to categorize these as related to “problem-solving” and “communication”.

For contextual understanding, in order to enhance the accuracy of feature extraction, embodiments incorporate additional contextual information such as job industry, role, location, tenure and department. This context-aware approach enables the LLMs to interpret the sentiment accurately, considering the relevance of the information. For example, “There were two accidents under his supervision last year” can be interpreted differently based on the job context, such as a neutral statement for a foundry worker versus a negative one for a truck driver. By including such context in the prompt, embodiments significantly improve the accuracy of the sentiment analysis.

For aspect weights, embodiments determine the overall sentiment of the text, by using a weighted average of the aspect sentiments. The LLM is prompted to assign weights to various aspects, considering the job context to ensure an accurate weighting. This context-aware approach helps in accurately capturing the overall sentiment, providing a comprehensive view of the performance review.

The following pair of manager and employee (“Celine”) reviews are used as running examples to further illustrate embodiments of the invention. This pair of reviews are an example of “live” input data that is provided at 302, as well as one of many pairs of reviews that form the historical performance reviews at 307:
(1) Managers Review: Celine has stood out from the crowd once again this quarter. As both an individual contributor and a member on multiple team projects, Celine was able to take the lead and even beat the timeline on one project. Her problem solving skills pair well with an innate ability to work well with others. Celine has proven her capability to handle pressure and is more than ready to take on increased responsibility.
(2) Employee Review: Reflecting on this past quarter, I believe I have made meaningful contributions both individually and within team settings. I took the initiative to lead a project, successfully delivering it ahead of schedule, which was a rewarding experience. While I was able to manage the challenges and work well with my teammates, I recognize there were moments where I could have communicated more proactively. Overall, I have grown in handling high-pressure situations and feel increasingly confident in my problem-solving abilities. Looking ahead, I am eager to take on new challenges and responsibilities to continue developing my skills and supporting the team's goals.

In embodiments, the following feature extraction prompt for LLM 125 is implemented:
Please perform “Aspect, Evidence, Sentiment, Aspect Weight” Quadruple Extraction task.
Given a performance evaluation of a candidate along with their job description, the company's description, the industry description, pick up aspects from the performance and give their sentiment along with the evidence from the text. You must also provide an aspect weight that indicates how important this aspect will be towards the performance of the overall performance of the employee. You can use the descriptions provided for the job role, company and the industry to decide upon these aspect weights.

### Aspect:

Must be a phrase of 1-3 words
Aspect and its sentiment can be both implicit or explicit in the text.
The aspect should be as concise as possible

### Sentiment:

Must be one of [NEGATIVE, NEUTRAL, POSITIVE]

### Evidence:

Must be a substring of the given text.

### Aspect Weights:

Must be a value between in the range [0, 1] (both inclusive)

From reading the evidence, the humans should be able to understand why the aspect has been given its respective sentiment. At the end, explain why you picked the sentiment for each aspect with a couple of sentences.

The output must be in the format of a single json code block such as:

```
‘‘‘json
[
  {
    “aspect”:
    “sentiment”:
    “evidence”:
    “aspect_weight”:
  },
  {
    “aspect”:
    “sentiment”:
    “evidence”:
    “aspect_weight”:
  },
  {
    “aspect”:
    “sentiment”:
    “evidence”:
    “aspect_weight”:
  }
]
’’’
```

Table 1 below illustrates an example of the features (i.e., aspect quadruples) extracted from a given review by LLMs 125 at 308:

TABLE 1
Managers Review: Celine has stood out from the crowd once again
this quarter. As both an individual contributor and a member
on multiple team projects, Celine was able to take the lead
and even beat the timeline on one project. Her problem solving
skills pair well with an innate ability to work well with others.
Celine has proven her capability to handle pressure and is
more than ready to take on increased responsibility.

| | | | Aspect |
|---|---|---|---|
| Aspect | Evidence | Sentiment | Weight |
| performance | Celine has stood out from the | Positive | 0.20 |
| | crowd once again this quarter | | |
| collaboration | a member on multiple team | Positive | 0.20 |
| | projects | | |
| leadership | Celine was able to take the lead | Positive | 0.10 |
| | and even beat the timeline on | | |
| | one project | | |
| problem- | Her problem solving skills pair | Positive | 0.05 |
| solving | well with an innate ability to work | | |
| | well with others | | |
| teamwork | Her problem solving skills pair | Positive | 0.05 |
| | well with an innate ability to work | | |
| | well with others | | |
| pressure | Celine has proven her capability | Neutral | 0.10 |
| handling | to handle pressure | | |
| responsibility | is more than ready to take on | Positive | 0.30 |
| | increased responsibility | | |

Embodiments utilize the extracted aspect, evidence and sentiment triplets from historical data 307 as training data in order to train transformer based deep learning model 306 which is specifically designed to generate sentiment scores for the textual data. In embodiments, deep learning model 306 is trained to classify the sentiment of each triplet (i.e., the review text, the identified aspect, and the corresponding evidence) into one of three sentiment classes: Positive, Neutral, or Negative.

Embodiments implement deep learning model 306 (or model 126) because LLMs 125, in general, cannot quantify the sentiment precisely. The sentiment needs to be quantified to provide accurate mismatch scores of sentiments between managers and employees in performance evaluations. For example, between “I think I did a good job” and “Ravi did a great job”, while both statements are positive, it is clear that the latter expresses a stronger positive sentiment. Embodiments achieve this type of granular understanding of sentiment through quantification.

For “live” data at 302 (i.e., a “new” performance review that consists of text data that needs to be analyzed), at 304, one or more LLMs 125 are used to extract aspects, evidence, sentiments and aspect weight (i.e., the same functionality at 308). Trained model 306 takes as input the triplet—the review text, the identified aspect, and the corresponding evidence—and maps it to the appropriate sentiment label. The output 310 of this classification process (i.e., the probabilities for each sentiment class) is referred to as a “sentiment score.”

Model 306 takes as input the triplet—comprising the review text, the identified aspect, and the corresponding evidence—and maps it to the appropriate sentiment label. The output of this classification process—the probabilities for each sentiment class—can be referred to as sentiment scores. An example output of model 306, in response to the following “live” input: (1) Evidence: Her problem solving skills pair well with an innate ability to work well with others; (2) Aspect: Teamwork, is as follows on Table 2 below:

TABLE 2

| Sentiment | Probability |
|---|---|
| NEGATIVE | 0.00 |
| NEUTRAL | 0.20 |
| POSITIVE | 0.80 |

At 312, embodiments perform an aspect level alignment analysis, which performs sentiment analysis at the granular level, breaking down reviews into specific aspects and evaluating sentiments for each aspect separately. An alignment/mismatch score is determined for each aspect that appears in both manager and employees reviews.

Embodiments use the Jensen-Shannon Divergence (“JSD”) to obtain the mismatch score. JSD is a statistical measure that effectively measures the “mismatch” or “divergence” between two probability distributions. The sentiment scores at 310, derived from the pretrained model 306 trained on features extracted by the LLM, are already provided as probability distributions. JSD ranges between 0 and 1 (for log base 2), where 0 indicates identical distributions, and values close to 1 indicate significant differences.

JSD between two probability distributions P and Q is defined as:

$$J S D ( P ‖ Q ) = \frac{1}{2} ( {D}_{K L} ( P ‖ M ) + {D}_{K L} ( Q ‖ M ) )$$

$$where :$$

$$M = \frac{1}{2} ( P + Q ) is the average of P and Q .$$

D_{KL}(P∥M) is the Kullback-Leibler divergence of P from M.
D_{KL}(Q∥M) is the Kullback-Leibler divergence of Q from M.

The Kullback-Leibler (“KL”) divergence D_{KL}(A∥B) is given by:

$${D}_{K L} ( A ‖ B ) = {\sum }_{x} A ( x ) log \frac{A ( x )}{B ( x )}$$

Table 3 below presents an example of the mismatch scores, calculated using JSD, for the aspects identified in both reviews. For brevity, the individual sentiment scores have been omitted.

TABLE 3
Managers Review: Celine has stood out from the crowd once
again this quarter. As both an individual contributor and a
member on multiple team projects, Celine was able to take the
lead and even beat the timeline on one project. Her problem
solving skills pair well with an innate ability to work well
with others. Celine has proven her capability to handle pressure
and is more than ready to take on increased responsibility.
Employees Review: I have won the star performer of the month
award twice this quarter. I've aimed to lead more projects but was
only able to lead one. I did lead that project well and delivered it
on time. While my work quality and consistency have been strong,
I'm aware that I could be more proactive in seeking new challenges.
However, there is still a lot to learn in my current role, so
I am not yet ready to take on more responsibilities.

| | Managers | Employees | Mismatch |
|---|---|---|---|
| Aspect | Sentiment | Sentiment | Score |
| Performance | Positive | Positive | 0.0 |
| Teamwork | Positive | Positive | 0.1 |
| Leadership | Positive | Negative | 0.4 |
| Punctuality | Positive | Positive | 0.0 |
| Responsibilities | Positive | Negative | 0.9 |

To determine the overall mismatch between manager and employee sentiments, embodiments calculate a weighted average of the aspect-level alignment scores. This ensures that aspects with higher importance, reflected by their weight, contribute more significantly to the overall alignment score.

In embodiments, for each aspect, a quadruple (aspect, evidence, sentiment, aspect weight) is extracted. Embodiments attempt to match the aspects that are present in both the manager and employee. Embodiments use the sentiment scores to get a mismatch score. Embodiments use the average of aspect weights from manager and employee as the aspect weight. For example:
Manager Quadruple: (Aspect=Leadership, <respective evidence from managers assessment of employee>, <respective sentiment score>, aspect_weight=0.4);
Employee Quadruple: (Aspect=Leadership, <respective evidence from employees self assessment>, <respective sentiment score>, aspect_weight=0.3);
Result: (Aspect=Leadership, Manager Sentiment, Employee Sentiment, Mismatch Score based individual sentiment scores, Aspect Weight=(0.4+0.3)/2, Weighted mismatch=mismatch*aspect weight).
Embodiment can normalize the aspect weights if it finds that the aspect weights do not sum up to 1 after the above methodology.

To match aspects from the manager and employee, embodiments use techniques such as semantic matching, word embeddings distance, etc. LLMs 125 can understand the context of the job, job role, job industry, company, etc., and decide upon aspect weight based on the datasets it has been trained on. Embodiments merely have to show it a couple of examples in the few shot prompting techniques.

The rationale for using a weighted average is rooted in the varying significance of different aspects in performance reviews. Aspects with higher weights are deemed more critical in evaluating performance, and thus, mismatches in these areas should have a greater impact on the overall mismatch score.

For example, consider a scenario where a high-weight aspect, such as leadership ability, shows significant misalignment between the manager's and employee's sentiments, while several lower-weight aspects, such as punctuality, align well. Despite the alignment in lower-weight aspects, the substantial misalignment in the high-weight aspect suggests a more pronounced overall misalignment. Therefore, the overall alignment score will reflect this by giving more emphasis to the high-weight aspects where discrepancies are observed.

In essence, the weighted average approach accounts for the relative importance of each aspect, ensuring that critical areas of performance receive appropriate consideration in the final alignment score. Therefore, embodiments provide a more nuanced and accurate representation of the alignment between manager and employee sentiments, highlighting areas where significant misalignments exist.

Table 4 below is an example where LLM at 304 assigns weights to various aspects, and the overall alignment score is calculated by taking a weighted average of the alignment scores for these aspects.

TABLE 4
Managers Review: Celine has stood out from the crowd once
again this quarter. As both an individual contributor and a
member on multiple team projects, Celine was able to take the
lead and even beat the timeline on one project. Her problem
solving skills pair well with an innate ability to work well
with others. Celine has proven her capability to handle pressure
and is more than ready to take on increased responsibility.
Employees Review: I have won the start performer of the month
award twice this quarter. I've aimed to lead more projects but was
only able to lead one. I did lead that project well and delivered it
on time. While my work quality and consistency have been strong,
I'm aware that I could be more proactive in seeking new challenges.
However, there is still a lot to learn in my current role, so
I am not yet ready to take on more responsibilities.

| | Managers | Employees | Mismatch | Aspect | Weighted |
|---|---|---|---|---|---|
| Aspect | Sentiment | Sentiment | Score | Weight | Mismatch |
| Performance | Positive | Positive | 0.0 | 0.3 | 0.00 |
| Teamwork | Positive | Positive | 0.1 | 0.2 | 0.16 |
| Leadership | Positive | Negative | 0.4 | 0.2 | 0.02 |
| Punctuality | Positive | Positive | 0.0 | 0.1 | 0.01 |
| Respon- | Positive | Negative | 0.9 | 0.2 | 0.18 |
| sibilities | | | | | |

| | |
|---|---|
| Overall Alignment | 0.29 |

At 314, various reporting is generated to leverage the extracted features for actionable insights. One type of report is for validating employee ratings. By comparing the rankings of employees based on manager ratings and the overall sentiment of the manager's comments, embodiments can identify inconsistencies. A low Spearman rank correlation between these two rankings indicate a discrepancy, suggesting inconsistencies or potential biases in the manager's evaluations. Therefore, embodiments provide a validation tool for the consistency and fairness of employee ratings.

Another type of report is aggregation analysis. With the extracted aspect and sentiment features, embodiments can perform aggregation analysis at the team, department, or organizational level to uncover valuable business insights. By identifying common themes across all employee comments within a specific group, embodiments can highlight key focus areas. For example, in a research and development department, “innovation” would be expected to emerge as a prominent theme. This thematic analysis helps organizations understand what aspects are most frequently discussed and valued by the managers and employees.

Further, analyzing the average alignment score of a manager, calculated as the average alignment score between the manager and all their direct reports, can reveal potential communication gaps. A low average alignment score may indicate a mismatch in expectations or perceptions between the manager and their team, suggesting areas where improved communication and clarity are needed. This comprehensive analysis provides a deeper understanding of team dynamics and organizational culture.

Another type of report is trend analysis. Traditional year-over-year performance ratings lack the granularity to identify specific areas of improvement or decline. Embodiments offer a more detailed trend analysis at the aspect level, allowing organizations to track changes in sentiment over time. This analysis provides a nuanced understanding of an employee's development, highlighting strengths, weaknesses, and areas for growth plotted against time.

At 316, action prescriptions are generated and delivered. The ultimate goal of performance evaluations is to help employees understand their strengths and weaknesses and guide them towards improvement. Embodiments provide specific, targeted action items. There are two primary sources for these prescriptions:

The first source is performance review comments of high-performing candidates. Analyzing the reviews of highly rated employees allows embodiments to identify aspects with low mismatch scores, indicating strong alignment between manager and employee sentiments. This insight can then be leveraged to recommend actions and behaviors for other employees to emulate, promoting successful practices across the organization.

The second source is sentiment gaps. By identifying discrepancies between employee and manager perceptions, embodiments can provide targeted feedback to address these gaps. For example, if an employee believes they excelled in an area where the manager disagreed, embodiments can provide specific actions to align their performance with managers' expectations.

### Data Analytics Environment

In one embodiment, embodiments of the invention are implemented as part of a cloud based data analytics environment. In general, data analytics enables the computer-based examination or analysis of large amounts of data, in order to derive conclusions or other information from that data; while business intelligence tools provide an organization's business users with information describing their enterprise data in a format that enables those business users to make strategic business decisions.

Examples of data analytics environments and business intelligence tools/servers include Oracle Business Intelligence Server (“OBIS”), Oracle Analytics Cloud (“OAC”), and Fusion Analytics Warehouse (“FAW”), which support features such as data mining or analytics, and analytic applications.

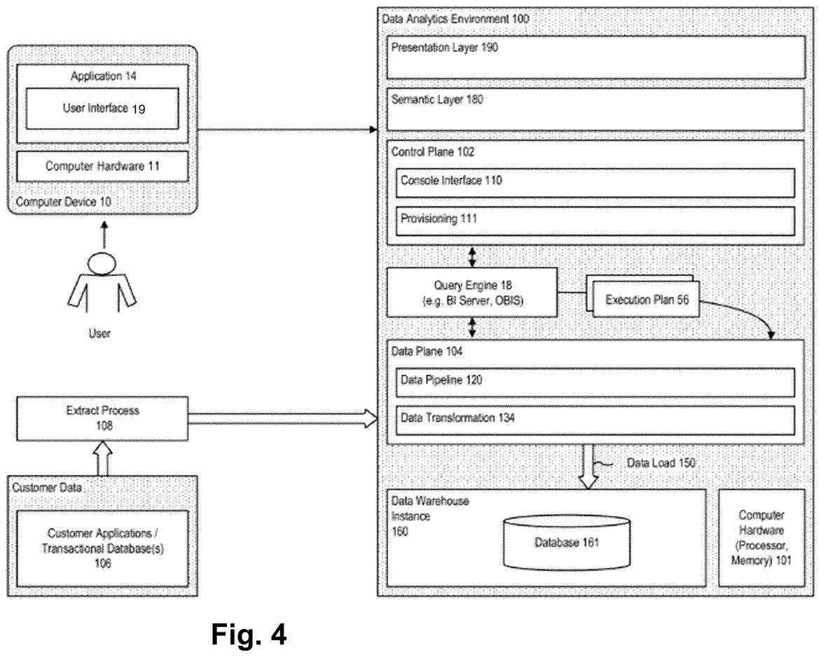

FIG. 4 illustrates an example data analytics environment, in accordance with an embodiment. The example embodiment illustrated in FIG. 4 is provided for purposes of illustrating an example of a data analytics environment in association with which various embodiments described herein can be used. In accordance with other embodiments and examples, the approach described herein can be used with other types of data analytics, database, or data warehouse environments. The components and processes illustrated in FIG. 4, and as further described herein with regard to various other embodiments, can be provided as software or program code executable by, for example, a cloud computing system, or other suitably-programmed computer system.

As illustrated in FIG. 4, in accordance with an embodiment, a data analytics environment 100 can be provided by, or otherwise operate at, a computer system having a computer hardware (e.g., processor, memory) 101, and including one or more software components operating as a control plane 102, and a data plane 104, and providing access to a data warehouse, data warehouse instance 160, database 161, or other type of data source.

In accordance with an embodiment, the control plane operates to provide control for cloud or other software products offered within the context of a SaaS or cloud environment, such as, for example, an Oracle Analytics Cloud environment, or other type of cloud environment. For example, in accordance with an embodiment, the control plane can include a console interface 110 that enables access by a customer (tenant) and/or a cloud environment having a provisioning component 111.

In accordance with an embodiment, the console interface can enable access by a customer (tenant) operating a graphical user interface (“GUI”) and/or a command-line interface (“CLI”) or other interface; and/or can include interfaces for use by providers of the SaaS or cloud environment and its customers (tenants). For example, in accordance with an embodiment, the console interface can provide interfaces that allow customers to provision services for use within their SaaS environment, and to configure those services that have been provisioned.

In accordance with an embodiment, a customer (tenant) can request the provisioning of a customer schema within the data warehouse. The customer can also supply, via the console interface, a number of attributes associated with the data warehouse instance, including required attributes (e.g., login credentials), and optional attributes (e.g., size, or speed). The provisioning component can then provision the requested data warehouse instance, including a customer schema of the data warehouse; and populate the data warehouse instance with the appropriate information supplied by the customer.

In accordance with an embodiment, the provisioning component can also be used to update or edit a data warehouse instance, and/or an extract, transform, and load (“ETL”) process that operates at the data plane, for example, by altering or updating a requested frequency of ETL process runs, for a particular customer (tenant).

In accordance with an embodiment, the data plane can include a data pipeline or process layer 120 and a data transformation layer 134, that together process operational or transactional data from an organization's enterprise software application or data environment, such as, for example, business productivity software applications provisioned in a customer's (tenant's) SaaS environment. The data pipeline or process can include various functionality that extracts transactional data from business applications and databases that are provisioned in the SaaS environment, and then load a transformed data into the data warehouse.

In accordance with an embodiment, the data transformation layer can include a data model, such as, for example, a knowledge model (“KM”), or other type of data model, that the system uses to transform the transactional data received from business applications and corresponding transactional databases provisioned in the SaaS environment, into a model format understood by the data analytics environment. The model format can be provided in any data format suited for storage in a data warehouse. In accordance with an embodiment, the data plane can also include a data and configuration user interface, and mapping and configuration database.

In accordance with an embodiment, the data plane is responsible for performing ETL operations, including extracting transactional data from an organization's enterprise software application or data environment, such as, for example, business productivity software applications and corresponding transactional databases offered in a SaaS environment, transforming the extracted data into a model format, and loading the transformed data into a customer schema of the data warehouse.

For example, in accordance with an embodiment, each customer (tenant) of the environment can be associated with their own customer tenancy within the data warehouse, that is associated with their own customer schema; and can be additionally provided with read-only access to the data analytics schema, which can be updated by a data pipeline or process, for example, an ETL process, on a periodic or other basis.

In accordance with an embodiment, a data pipeline or process can be scheduled to execute at intervals (e.g., hourly/daily/weekly) to extract transactional data from an enterprise software application or data environment, such as, for example, business productivity software applications and corresponding transactional databases 106 that are provisioned in the SaaS environment.

In accordance with an embodiment, an extract process 108 can extract the transactional data, whereupon extraction of the data pipeline or process can insert extracted data into a data staging area, which can act as a temporary staging area for the extracted data. The data quality component and data protection component can be used to ensure the integrity of the extracted data. For example, in accordance with an embodiment, the data quality component can perform validations on the extracted data while the data is temporarily held in the data staging area.

In accordance with an embodiment, when the extract process has completed its extraction, the data transformation layer can be used to begin the transform process, to transform the extracted data into a model format to be loaded into the customer schema of the data warehouse.

In accordance with an embodiment, the data pipeline or process can operate in combination with the data transformation layer to transform data into the model format. The mapping and configuration database can store metadata and data mappings that define the data model used by data transformation. The data and configuration user interface (“UI”) can facilitate access and changes to the mapping and configuration database.

In accordance with an embodiment, the data transformation layer can transform extracted data into a format suitable for loading into a customer schema of data warehouse, for example according to the data model. During the transformation, the data transformation can perform dimension generation, fact generation, and aggregate generation, as appropriate. Dimension generation can include generating dimensions or fields for loading into the data warehouse instance.

In accordance with an embodiment, after transformation of the extracted data, the data pipeline or process can execute a warehouse load procedure 150 to load the transformed data into the customer schema of the data warehouse instance. Subsequent to the loading of the transformed data into customer schema, the transformed data can be analyzed and used in a variety of additional business intelligence processes.

Different customers of a data analytics environment may have different requirements with regard to how their data is classified, aggregated, or transformed, for purposes of providing data analytics or business intelligence data, or developing software analytic applications. In accordance with an embodiment, to support such different requirements, a semantic layer 180 can include data defining a semantic model of a customer's data; which is useful in assisting users in understanding and accessing that data using commonly-understood business terms; and provide custom content to a presentation layer 190.

In accordance with an embodiment, a semantic model can be defined, for example, in an Oracle environment, as a BI Repository (“RPD”) file, having metadata that defines logical schemas, physical schemas, physical-to-logical mappings, aggregate table navigation, and/or other constructs that implement the various physical layer, business model and mapping layer, and presentation layer aspects of the semantic model.

In accordance with an embodiment, a customer may perform modifications to their data source model, to support their particular requirements, for example by adding custom facts or dimensions associated with the data stored in their data warehouse instance; and the system can extend the semantic model accordingly.

In accordance with an embodiment, the presentation layer can enable access to the data content using, for example, a software analytic application, user interface, dashboard, key performance indicators (“KPI”'s); or other type of report or interface as may be provided by products such as, for example, Oracle Analytics Cloud, or Oracle Analytics for Applications.

In accordance with an embodiment, a query engine 18 (e.g., OBIS) operates in the manner of a federated query engine to serve analytical queries within, e.g., an Oracle Analytics Cloud environment, via SQL, pushes down operations to supported databases, and translates business user queries into appropriate database-specific query languages (e.g., Oracle SQL, SQL Server SQL, DB2 SQL, or Essbase MDX). The query engine (e.g., OBIS) also supports internal execution of SQL operators that cannot be pushed down to the databases.

In accordance with an embodiment, a user/developer can interact with a client computer device 10 that includes a computer hardware 11 (e.g., processor, storage, memory), user interface 19, and application 14. A query engine or business intelligence server such as OBIS generally operates to process inbound, e.g., SQL, requests against a database model, build and execute one or more physical database queries, process the data appropriately, and then return the data in response to the request.

To accomplish this, in accordance with an embodiment, the query engine or business intelligence server can include various components or features, such as a logical or business model or metadata that describes the data available as subject areas for queries; a request generator that takes incoming queries and turns them into physical queries for use with a connected data source; and a navigator that takes the incoming query, navigates the logical model and generates those physical queries that best return the data required for a particular query.

For example, in accordance with an embodiment, a query engine or business intelligence server may employ a logical model mapped to data in a data warehouse, by creating a simplified star schema business model over various data sources so that the user can query data as if it originated at a single source. The information can then be returned to the presentation layer as subject areas, according to business model layer mapping rules.

In accordance with an embodiment, the query engine (e.g., OBIS) can process queries against a database according to a query execution plan 56, that can include various child (leaf) nodes, generally referred to herein in various embodiments as RqLists, and produces one or more diagnostic log entries. Within a query execution plan, each execution plan component (RqList) represents a block of query in the query execution plan, and generally translates to a SELECT statement. An RqList may have nested child RqLists, similar to how a SELECT statement can select from nested SELECT statements.

In accordance with an embodiment, during operation the query engine or business intelligence server can create a query execution plan which can then be further optimized, for example to perform aggregations of data necessary to respond to a request. Data can be combined together and further calculations applied, before the results are returned to the calling application, for example via the ODBC interface.

In accordance with an embodiment, a complex, multi-pass request that requires multiple data sources may require the query engine or business intelligence server to break the query down, determine which sources, multi-pass calculations, and aggregates can be used, and generate the logical query execution plan spanning multiple databases and physical SQL statements, wherein the results can then be passed back, and further joined or aggregated by the query engine or business intelligence server.

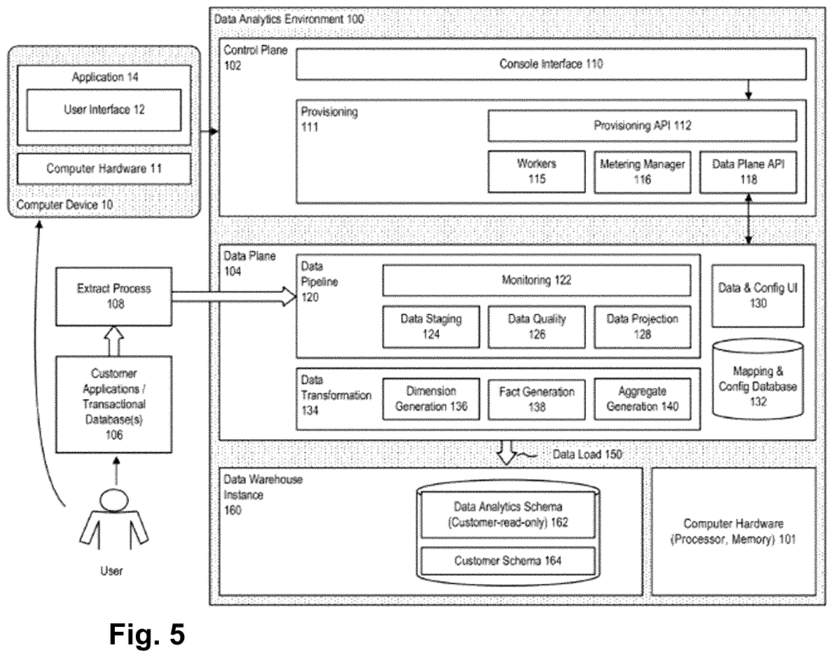

FIG. 5 further illustrates an example data analytics environment, in accordance with an embodiment. As illustrated in FIG. 5, in accordance with an embodiment, the provisioning component can also comprise a provisioning application programming interface (“API”) 112, a number of workers 115, a metering manager 116, and a data plane API 118, as further described below. The console interface can communicate, for example, by making API calls, with the provisioning API when commands, instructions, or other inputs are received at the console interface to provision services within the SaaS environment, or to make configuration changes to provisioned services.

In accordance with an embodiment, the data plane API can communicate with the data plane. For example, in accordance with an embodiment, provisioning and configuration changes directed to services provided by the data plane can be communicated to the data plane via the data plane API.

In accordance with an embodiment, the metering manager can include various functionality that meters services and usage of services provisioned through control plane. For example, in accordance with an embodiment, the metering manager can record a usage over time of processors provisioned via the control plane, for particular customers (tenants), for billing purposes. Likewise, the metering manager can record an amount of storage space of data warehouse partitioned for use by a customer of the SaaS environment, for billing purposes.

In accordance with an embodiment, the data pipeline or process, provided by the data plane, can including a monitoring component 122, a data staging component 124, a data quality component 126, and a data projection component 128, as further described below.

In accordance with an embodiment, the data transformation layer can include a dimension generation component 136, fact generation component 138, and aggregate generation component 140, as further described below. The data plane can also include a data and configuration user interface 130, and mapping and configuration database 132.

In accordance with an embodiment, the data warehouse can include a default data analytics schema (referred to herein in accordance with some embodiments as an analytic warehouse schema) 162 and, for each customer (tenant) of the system, a customer schema 164.

In accordance with an embodiment, to support multiple tenants, the system can enable the use of multiple data warehouses or data warehouse instances. For example, in accordance with an embodiment, a first warehouse customer tenancy for a first tenant can comprise a first database instance, a first staging area, and a first data warehouse instance of a plurality of data warehouses or data warehouse instances; while a second customer tenancy for a second tenant can comprise a second database instance, a second staging area, and a second data warehouse instance of the plurality of data warehouses or data warehouse instances.

In accordance with an embodiment, based on the data model defined in the mapping and configuration database, the monitoring component can determine dependencies of several different data sets to be transformed. Based on the determined dependencies, the monitoring component can determine which of several different data sets should be transformed to the model format first.

For example, in accordance with an embodiment, if a first model dataset incudes no dependencies on any other model data set; and a second model data set includes dependencies to the first model data set; then the monitoring component can determine to transform the first data set before the second data set, to accommodate the second data set's dependencies on the first data set.

For example, in accordance with an embodiment, dimensions can include categories of data such as, for example, “name,” “address,” or “age”. Fact generation includes the generation of values that data can take, or “measures.” Facts can be associated with appropriate dimensions in the data warehouse instance. Aggregate generation includes creation of data mappings which compute aggregations of the transformed data to existing data in the customer schema of data warehouse instance.

In accordance with an embodiment, once any transformations are in place (as defined by the data model), the data pipeline or process can read the source data, apply the transformation, and then push the data to the data warehouse instance.

In accordance with an embodiment, data transformations can be expressed in rules, and once the transformations take place, values can be held intermediately at the staging area, where the data quality component and data projection components can verify and check the integrity of the transformed data, prior to the data being uploaded to the customer schema at the data warehouse instance. Monitoring can be provided as the extract, transform, load process runs, for example, at a number of compute instances or virtual machines. Dependencies can also be maintained during the extract, transform, load process, and the data pipeline or process can attend to such ordering decisions.

In accordance with an embodiment, after transformation of the extracted data, the data pipeline or process can execute a warehouse load procedure, to load the transformed data into the customer schema of the data warehouse instance. Subsequent to the loading of the transformed data into customer schema, the transformed data can be analyzed and used in a variety of additional business intelligence processes.

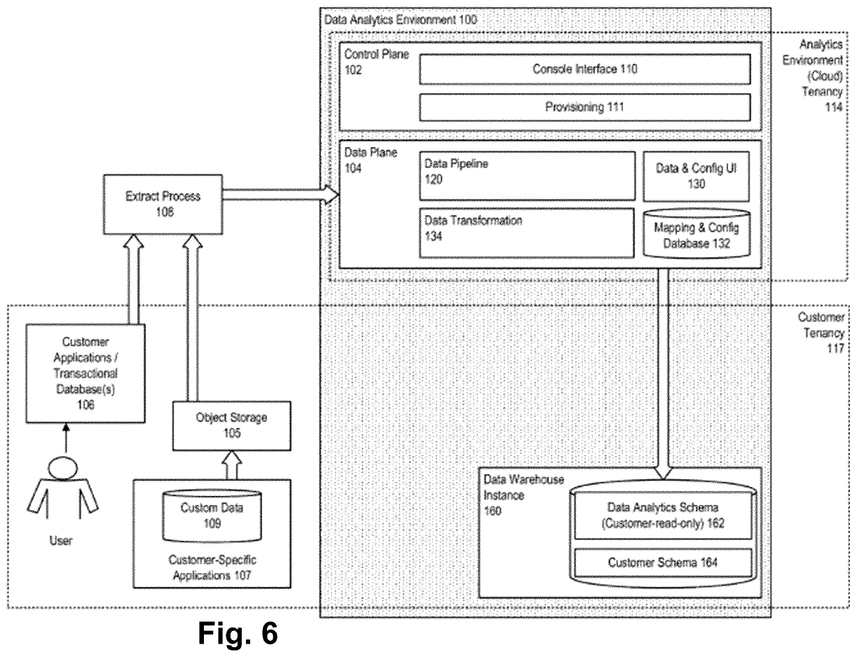

FIG. 6 further illustrates an example data analytics environment, in accordance with an embodiment. As illustrated in FIG. 6, in accordance with an embodiment, data can be sourced, e.g., from a customer's (tenant's) enterprise software application or data environment (106), using the data pipeline process; or as custom data 109 sourced from one or more customer-specific applications 107; and loaded to a data warehouse instance, including in some examples the use of an object storage 105 for storage of the data.

In accordance with embodiments of analytics environments such as, for example, Oracle Analytics Cloud (“OAC”), a user can create a data set that uses tables from different connections and schemas. The system uses the relationships defined between these tables to create relationships or joins in the data set.

In accordance with an embodiment, for each customer (tenant), the system uses the data analytics schema that is maintained and updated by the system, within a system/cloud tenancy 114, to pre-populate a data warehouse instance for the customer, based on an analysis of the data within that customer's enterprise applications environment, and within a customer tenancy 117. As such, the data analytics schema maintained by the system enables data to be retrieved, by the data pipeline or process, from the customer's environment, and loaded to the customer's data warehouse instance.

In accordance with an embodiment, the system also provides, for each customer of the environment, a customer schema that is readily modifiable by the customer, and which allows the customer to supplement and utilize the data within their own data warehouse instance. For each customer, their resultant data warehouse instance operates as a database whose contents are partly-controlled by the customer; and partly-controlled by the environment (system).

For example, in accordance with an embodiment, a data warehouse (e.g., ADW) can include a data analytics schema and, for each customer/tenant, a customer schema sourced from their enterprise software application or data environment. The data provisioned in a data warehouse tenancy (e.g., an ADW cloud tenancy) is accessible only to that tenant; while at the same time allowing access to various, e.g., ETL-related or other features of the shared environment.

In accordance with an embodiment, to support multiple customers/tenants, the system enables the use of multiple data warehouse instances; wherein for example, a first customer tenancy can comprise a first database instance, a first staging area, and a first data warehouse instance; and a second customer tenancy can comprise a second database instance, a second staging area, and a second data warehouse instance.

In accordance with an embodiment, for a particular customer/tenant, upon extraction of their data, the data pipeline or process can insert the extracted data into a data staging area for the tenant, which can act as a temporary staging area for the extracted data. A data quality component and data protection component can be used to ensure the integrity of the extracted data; for example by performing validations on the extracted data while the data is temporarily held in the data staging area. When the extract process has completed its extraction, the data transformation layer can be used to begin the transformation process, to transform the extracted data into a model format to be loaded into the customer schema of the data warehouse.

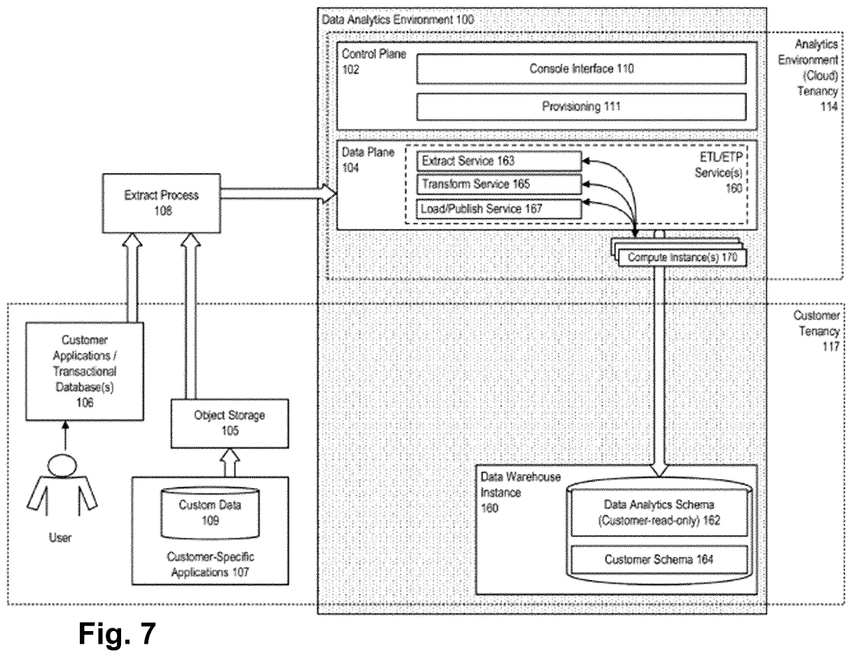

FIG. 7 further illustrates an example data analytics environment, in accordance with an embodiment. As illustrated in FIG. 7, in accordance with an embodiment, the process of extracting data, e.g., from a customer's (tenant's) enterprise software application or data environment, using the data pipeline process as described above; or as custom data sourced from one or more customer-specific applications; and loading the data to a data warehouse instance, or refreshing the data in a data warehouse, generally involves three broad stages, performed by an ETP service 160 or process, including one or more extraction service 163; transformation service 165; and load/publish service 167, executed by one or more compute instance(s) 170.

For example, in accordance with an embodiment, a list of view objects for extractions can be submitted, for example, to an Oracle BI Cloud Connector (“BICC”) component via a ReST call. The extracted files can be uploaded to an object storage component, such as, for example, an Oracle Storage Service (“OSS”) component, for storage of the data. The transformation process takes the data files from object storage component (e.g., OSS), and applies a business logic while loading them to a target data warehouse, e.g., an ADW database, which is internal to the data pipeline or process, and is not exposed to the customer (tenant). A load/publish service or process takes the data from the, e.g., ADW database or warehouse, and publishes it to a data warehouse instance that is accessible to the customer (tenant).

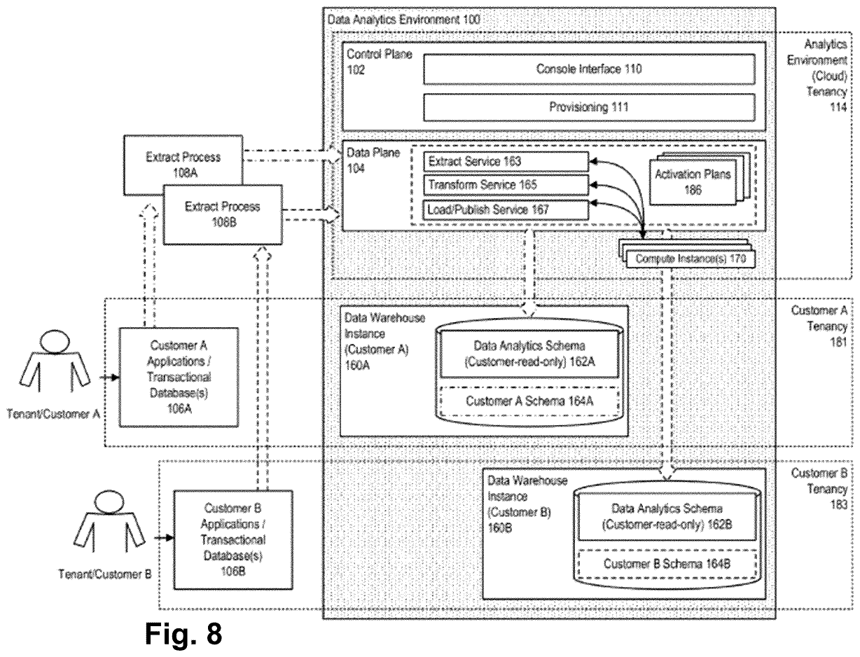

FIG. 8 further illustrates an example data analytics environment, in accordance with an embodiment. As illustrated in FIG. 8, which illustrates the operation of the system with a plurality of tenants (customers) in accordance with an embodiment, data can be sourced, e.g., from each of a plurality of customer's (tenant's) enterprise software application or data environment, using the data pipeline process as described above; and loaded to a data warehouse instance.

In accordance with an embodiment, the data pipeline or process maintains, for each of a plurality of customers (tenants), for example customer A 180, customer B 182, a data analytics schema that is updated on a periodic basis, by the system in accordance with best practices for a particular analytics use case.

In accordance with an embodiment, for each of a plurality of customers (e.g., customers A, B), the system uses the data analytics schema 162A, 162B, that is maintained and updated by the system, to pre-populate a data warehouse instance for the customer, based on an analysis of the data within that customer's enterprise applications environment 106A, 106B, and within each customer's tenancy (e.g., customer A tenancy 181, customer B tenancy 183); so that data is retrieved, by the data pipeline or process, from the customer's environment, and loaded to the customer's data warehouse instance 160A, 160B.

In accordance with an embodiment, the data analytics environment also provides, for each of a plurality of customers of the environment, a customer schema (e.g., customer A schema 164A, customer B schema 164B) that is readily modifiable by the customer, and which allows the customer to supplement and utilize the data within their own data warehouse instance.

As described above, in accordance with an embodiment, for each of a plurality of customers of the data analytics environment, their resultant data warehouse instance operates as a database whose contents are partly-controlled by the customer; and partly-controlled by the data analytics environment (system); including that their database appears pre-populated with appropriate data that has been retrieved from their enterprise applications environment to address various analytics use cases. When the extract process 108A, 108B for a particular customer has completed its extraction, the data transformation layer can be used to begin the transformation process, to transform the extracted data into a model format to be loaded into the customer schema of the data warehouse.

In accordance with an embodiment, activation plans 186 can be used to control the operation of the data pipeline or process services for a customer, for a particular functional area, to address that customer's (tenant's) particular needs.

For example, in accordance with an embodiment, an activation plan can define a number of extract, transform, and load (publish) services or steps to be run in a certain order, at a certain time of day, and within a certain window of time.

In accordance with an embodiment, each customer can be associated with their own activation plan(s). For example, an activation plan for a first Customer A can determine the tables to be retrieved from that customer's enterprise software application environment (e.g., their Fusion Applications environment), or determine how the services and their processes are to run in a sequence; while an activation plan for a second Customer B can likewise determine the tables to be retrieved from that customer's enterprise software application environment, or determine how the services and their processes are to run in a sequence.

As disclosed, embodiments implement accurate sentiment scoring with custom-built datasets. In contrast, traditional Natural Language Processing (“NLP”) techniques often lack accuracy due to their reliance on hard-coded rules, which fail to capture the nuances of language. This results in sentiment scores that are often oversimplified or imprecise. In contrast, ML/DL models generally offer more accurate sentiment analysis but come with their own set of challenges. These models need to be trained on datasets that closely match the distribution of the target domain to perform well. However, widely available sentiment datasets are typically not aligned with the specific context of performance reviews, making them unsuitable for this niche use case. Consequently, there is often a need to manually create a specialized dataset, which can be both time-consuming and costly.

Embodiments address this challenge by leveraging a LLM to automatically extract historical aspect, evidence, and sentiment triplets from prior reviews. Using these extracted features, embodiments construct a new dataset where the input consists of (review, aspect, evidence) and the output is the corresponding sentiment. This enriched dataset is then employed to train a transformer-based deep learning model, which effectively captures sentiment at the aspect level within performance reviews. Embodiments ensure precise sentiment scoring tailored specifically to the context of performance evaluations, eliminating the need for manual dataset creation.

To match aspects from the manager and employee, embodiments use techniques such as semantic matching, word embeddings distance, etc. LLMs 125 can understand the context of the job, job role, job industry, company, etc., and decide upon aspect weight based on the datasets it has been trained on. Embodiments merely have to show it a couple of examples in the few shot prompting techniques.

The features, structures, or characteristics of the disclosure described throughout this specification may be combined in any suitable manner in one or more embodiments. For example, the usage of “one embodiment,” “some embodiments,” “certain embodiment,” “certain embodiments,” or other similar language, throughout this specification refers to the fact that a particular feature, structure, or characteristic described in connection with the embodiment may be included in at least one embodiment of the present disclosure. Thus, appearances of the phrases “one embodiment,” “some embodiments,” “a certain embodiment,” “certain embodiments,” or other similar language, throughout this specification do not necessarily all refer to the same group of embodiments, and the described features, structures, or characteristics may be combined in any suitable manner in one or more embodiments.

One having ordinary skill in the art will readily understand that the embodiments as discussed above may be practiced with steps in a different order, and/or with elements in configurations that are different than those which are disclosed. Therefore, although this disclosure considers the outlined embodiments, it would be apparent to those of skill in the art that certain modifications, variations, and alternative constructions would be apparent, while remaining within the spirit and scope of this disclosure. In order to determine the metes and bounds of the disclosure, therefore, reference should be made to the appended claims.

What is claimed is:

1. A method of evaluating performance, the method comprising:
receiving a plurality of training performance reviews;
extracting from the training performance reviews, using a first machine learning model, a plurality of features comprising a training aspect, a training sentiment, and a corresponding training evidence;
using the extracted plurality of features to train a second machine learning model;
receiving a first performance review;
extracting from the first performance review one or more first aspects, one or more corresponding first evidences, and one or more corresponding first sentiments; and
using the trained second machine learning model, predicting first sentiment scores for each of the first aspects.

2. The method of claim 1, further comprising extracting from the first performance review one or more first aspect weights.

3. The method of claim 2, wherein the first performance review comprises a manager portion and an employee portion, further comprising:
determining a mismatch score for each of one or more first aspects that are common to the manager portion and the employee portion.

4. The method of claim 3, further comprising determining an overall mismatch first performance review based on the first aspect weights and the mismatch score.

5. The method of claim 1, wherein the first machine learning model comprises an large language learning model, and the second machine learning model comprises a deep learning model.

6. The method of claim 1, wherein the first performance review consists of textual data.

7. The method of claim 1, wherein the first sentiment comprises a negative, neutral or positive label, and the first sentiment score comprises a probability of belonging to one of the first sentiment.

8. The method of claim 4, further comprising extracting actional items.

9. A computer readable medium having instructions stored thereon that, when executed by one or more processors, cause the processor to evaluate performance, the evaluating performance comprising:
receiving a plurality of training performance reviews;
extracting from the training performance reviews, using a first machine learning model, a plurality of features comprising a training aspect, a training sentiment, and a corresponding training evidence;
using the extracted plurality of features to train a second machine learning model;
receiving a first performance review;
extracting from the first performance review one or more first aspects, one or more corresponding first evidences, and one or more corresponding first sentiments; and
using the trained second machine learning model, predicting first sentiment scores for each of the first aspects.

10. The computer readable medium of claim 9, the evaluating performance further comprising extracting from the first performance review one or more first aspect weights.

11. The computer readable medium of claim 10, wherein the first performance review comprises a manager portion and an employee portion, the evaluating performance further comprising:
determining a mismatch score for each of one or more first aspects that are common to the manager portion and the employee portion.

12. The computer readable medium of claim 11, the evaluating performance further comprising determining an overall mismatch first performance review based on the first aspect weights and the mismatch score.

13. The computer readable medium of claim 9, wherein the first machine learning model comprises a large language learning model, and the second machine learning model comprises a deep learning model.

14. The computer readable medium of claim 9, wherein the first performance review consists of textual data.

15. The computer readable medium of claim 9, wherein the first sentiment comprises a negative, neutral or positive label, and the first sentiment score comprises a probability of belonging to one of the first sentiment.

16. The computer readable medium of claim 12, the evaluating performance further comprising extracting actional items.

17. A performance evaluation system comprising:
a first machine learning model;
a second machine learning model;
one or more processors configured to:
receive a plurality of training performance reviews;
extract from the training performance reviews, using the first machine learning model, a plurality of features comprising a training aspect, a training sentiment, and a corresponding training evidence;
use the extracted plurality of features to train the second machine learning model;
receive a first performance review;
extract from the first performance review one or more first aspects, one or more corresponding first evidences, and one or more corresponding first sentiments; and
using the trained second machine learning model, predict first sentiment scores for each of the first aspects.

18. The system of claim 17, the processors further configured to extract from the first performance review one or more first aspect weights.

19. The system of claim 18, wherein the first performance review comprises a manager portion and an employee portion, the processors further configured to:
determine a mismatch score for each of one or more first aspects that are common to the manager portion and the employee portion.

20. The system of claim 19, the processors further configured to determine an overall mismatch first performance review based on the first aspect weights and the mismatch score.
